(19) United States
(12) Patent Application Publication
(10) Pub. No.: US 2013/0282907 A1
(43) Pub. Date: Oct. 24, 2013

(54) NETWORK SEPARATION APPARATUS AND METHOD

(71) Applicant: Electronics And Telecommunications Research Institute, (US)

(72) Inventors: Sun-Wook KIM, Hwaseong (KR); Dae-Won KIM, Daejeon (KR); Hak-Jae KIM, Daejeon (KR); Seong-Woon KIM, Gyeryong (KR)

(73) Assignee: ELECTRONICS AND TELECOMMUNICATIONS RESEARCH INSTITUTE, Daejeon-city (KR)

(21) Appl. No.: 13/863,767

(22) Filed: Apr. 16, 2013

(30) Foreign Application Priority Data
Apr. 23, 2012 (KR) 10-2012-0042320

(51) Int. Cl. H04L 12/24

(52) U.S. Cl. CPC H04L 41/08
USPC 709/226

(57) ABSTRACT

Disclosed herein is a network separation apparatus and method. The network separation apparatus according to the present invention includes a main processing unit for allocating resources according to a network to be accessed. An in-house processing unit accesses an in-house network using the resources allocated by the main processing unit. An external processing unit accesses an external network using resources, physically separated from resources used by the in-house processing unit, among the resources by the main processing unit.

### CROSS REFERENCE TO RELATED ED APPLICATION

This application claims the benefit of Korean Patent Application No. 10-2012-0042320, filed on Apr. 23, 2012, which is hereby incorporated by reference in its entirety into this application.

### BACKGROUND OF THE INVENTION

1. Technical Field

The present invention relates generally to a network separation apparatus and method and, more particularly, to a network separation apparatus and method, which separate an in-house network and an external network.

2. Description of the Related Art

With the development of computer technology, computers and computer networks have become widely used. In particular, not only an in-house network (an intra-company network), such as an intranet, but also an external network, such as the Internet, have been used to search for information, transmit and receive data, and transmit and receive emails in public institutions or businesses.

In this way, as an external network vulnerable to external attacks, as well as an in-house network, are being used, security technology for protecting internal important information against attacks made by attackers over the external network is required. Due to such a requirement, firewalls have been installed and operated in public institutions or businesses. However, it is difficult to perfectly protect internal important information against attacks, made by the attackers who penetrate the public institutions or businesses while bypassing the firewalls, and external premeditated attacks.

Accordingly, network separation technology for separating an in-house network and an external network has been introduced. Such network separation technology denotes technology for separating a network used for networking into at least two networks according to the purpose and preventing data from being transferred between the separated networks, so that even if security in one network becomes vulnerable to hacking or infection with malicious code, damage to the other network is prevented.

Such network separation technology can be mainly divided into physical network separation technology and logical network separation technology. Physical network separation technology is a technology for physically separating a network by providing all pieces of equipment in each of an in-house network and an external network This technology is problematic in that it is very expensive to provide all the pieces of equipment in each of the in-house network and the external network, and is also problematic in that a workspace is made smaller by the pieces of equipment provided in each of the in-house network and the external network.

Logical network separation technology is a technology for providing all pieces of equipment in a single server and logically separating a network via the server. However, this technology is problematic in that traffic is concentrated on the server, thus requiring large-capacity processing capability, and is also problematic in that when a plurality of terminals access the server and traffic explosively increases, processing capability is deteriorated.

Korean Patent Application Publication No. 2011-0100952 discloses a network separation apparatus for transmitting packets generated by a terminal to an in-house network or an external network by means of the logical separation of a network using a virtual environment. However, the technology disclosed in the above patent is problematic in that the logical network separation technology is adopted, so that traffic is concentrated, thus deteriorating processing capability.

Therefore, new technology for solving the problems of physical network separation technology and logical network separation technology is urgently required.

### SUMMARY OF THE INVENTION

Accordingly, the present invention has been made keeping in mind the above problems occurring in the prior art, and an object of the present invention is to provide a network separation apparatus that physically separates an in-house network and an external network.

Another object of the present invention is to provide a network separation method that physically separates an in-house network and an external network.

In accordance with an aspect of the present invention to accomplish the above objects, there is provided a network separation apparatus including a main processing unit for allocating resources according to a network to be accessed, an in-house processing unit for accessing an in-house network using the resources allocated by the main processing unit, and an external processing unit for accessing an external network using resources, physically separated from resources used by the in-house processing unit, among the resources by the main processing unit.

Preferably, the main processing unit may allocate a network interface module belonging to shared resources to the in-house processing unit, and allocates a network interface module physically separated from the shared resources to the external processing unit.

Preferably, the main processing unit may allocate a storage module belonging to shared resources to the in-house processing unit, and allocate a storage module physically separated from the shared resources to the external processing unit.

Preferably, the main processing unit may allocate in-house resources used to execute an in-house application to the in-house processing unit, and allocate external resources, physically separated from the in-house resources and used to execute an external application, to the external processing unit.

Preferably, the in-house processing unit may provide data, stored in a storage module belonging to shared resources among the resources allocated by the main processing unit, over an in-house network, and store data received over the in-house network in the storage module belonging to the shared resources.

Preferably, the external processing unit may provide data, stored in a storage module physically separated from a storage module used by the in-house processing unit among the resources allocated by the main processing unit, over an external network, and store data received over the external network in the storage module physically separated from the storage module used by the in-house processing unit.

In accordance with another aspect of the present invention to accomplish the above objects, there is provided a network separation method, the method being performed by a network separation apparatus for physically separating an in-house network and an external network, including allocating shared resources to at least two processing units included in the network separation apparatus, and allocating physically separated resources to the at least two processing units according to a network to be accessed.

Preferably, the allocating the shared resources to the at least two processing units included in the network separation apparatus may be configured to allocate at least one of a network interface module and a storage module that are the shared resources to a processing unit, which accesses the in-house network, among the at least two processing units.

Preferably, the allocating the physically separated resources to the at least two processing units according to the network to be accessed may be configured to allocate in-house resources used to execute an in-house application to a processing unit, which accesses the in-house network, among the at least two processing units.

Preferably, the allocating the physically separated resources to the at least two processing units according to the network to be accessed may be configured to allocate external resources used to execute an external application to a processing unit, which accesses the external network, among the at least two processing units.

Preferably, the allocating the physically separated resources to the at least two processing units according to the network to be accessed may be configured to allocate at least one of a network interface module and a storage module that are physically separated from the shared resources to a processing unit, which accesses the external network, among the at least two processing units.

Preferably, after the resources have been allocated according to the network to be accessed, the in-house network may be accessed based on a network interface module belonging to the shared resources among the allocated resources.

Preferably, after the resources have been allocated according to the network to be accessed, the external network may be accessed based on a network interface module physically separated from a network interface module belonging to the shared resources among the allocated resources.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the configuration of a network separation apparatus according to an embodiment of the present invention;

FIG. 2 is a conceptual diagram showing a network separation system according to an embodiment of the present invention; and

FIG. 3 is a flowchart showing the operation of a network separation method according to an embodiment of the present invention.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

Hereinafter, preferred embodiments of the present invention will be described in detail with reference to the attached drawings.

Throughout the entire specification, the term “in-house network” denotes a network such as an intranet, and the term “external network” denotes a network such as the Internet.

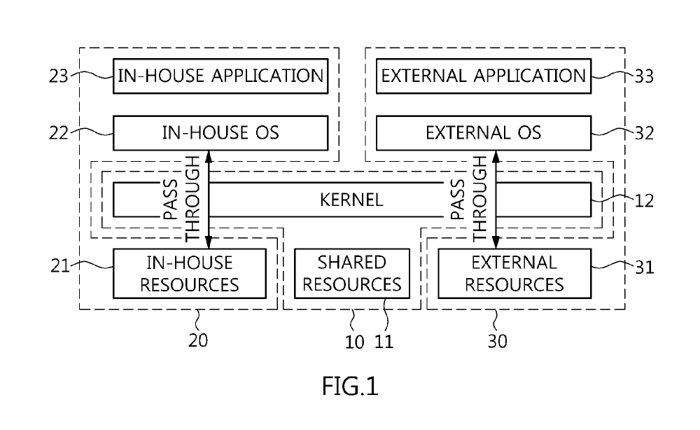

FIG. 1 is a block diagram showing the configuration of a network separation apparatus according to an embodiment of the present invention.

Referring to FIG. 1, a network separation apparatus according to an embodiment of the present invention includes a main processing unit 10, an in-house (intra-company) processing unit 20, and an external processing unit 30. Here, the main processing unit 10 may include shared resources 11 and a kernel 12. The kernel 12 may be operated based on the shared resources 11. The in-house processing unit 20 may include in-house resources 21, an in-house Operating System (OS) 22, and an in-house application 23. The in-house application 23 may be executed on the in-house OS 22, and the in-house OS 22 may be operated based on the shared resources 11 and the in-house resources 21. The external processing unit 30 includes external resources 31, an external OS 32, and an external application 33. The external application 33 may be executed on the external OS 32 and the external OS 32 may be operated based on the shared resources 11 and the external resources 31.

In this case, the network separation apparatus may be implemented as a desktop computer, a laptop computer, a tablet personal computer (PC), a wireless phone, a mobile phone, a smart phone, an e-book reader, a Portable Multimedia Player (PMP), a portable game console, a navigation device, a digital camera, a Digital Multimedia Broadcasting (DMB) player, a digital audio recorder, a digital audio player, a digital picture recorder, a digital picture player, a digital video recorder, a digital video player, a server, etc.

The shared resources 11, the in-house resources 21, and the external resources 31 may refer to hardware resources that are used by the network separation apparatus, and are physically separated resources.

The shared resources 11 are resources allocated to the in-house processing unit 20 and to the external processing unit 30, and the in-house processing unit 20 and the external processing unit 30 can share and use the shared resources 11. The shared resources 11 may include a processor such as a Central Processing Unit (CPU), a main memory unit (for example, Random Access Memory (RAM) or Read Only Memory (ROM)), a storage module such as an auxiliary memory unit (for example, a hard disk), a network interface module such as a Network Interface Card (MC), a Universal Serial Bus (USB) host controller, and a user interface device (for example, a display device, a keyboard, a mouse, a touch screen, etc.). Among the shared resources 11, the processor, the main memory unit, the USB host controller, and the user interface device can be allocated to the in-house processing unit 20 and the external processing unit 30. The storage module and the network interface module can be allocated to the in-house processing unit 20.

The in-house resources 21 are resources allocated to the in-house processing unit 20, and may include a graphics processing module such as a Video Graphics Array (VGA) card, an audio processing module such as an audio device, a USB host controller, etc. Here, the in-house resources 21 are resources required to execute the high-specification in-house application 32 and can have better performance than the shared resources 11.

The external resources 31 are resources allocated to the external processing unit 30, and may include a graphics processing module such as a VGA card, an audio processing module such as an audio device, a USB host controller, a network interface module such as an MC, a storage module such as an auxiliary memory unit, etc. Here, the external resources 31 are resources required to execute the high-specification external application 33, and may have better performance than the shared resources 11.

The kernel 12 may boot the network separation apparatus based on the shared resources 11 and may allocate shared resources 11 required for booting (for example, the processor, the main memory unit, etc.) to the in-house processing unit 20 and to the external processing unit 30 after the network separation apparatus has been booted.

The kernel 12 may virtualize the shared resources 11 and allocate the virtualized shared resources to the in-house processing unit 20 and the external processing unit 30. That is, the kernel 12 may allocate the network interface module and the storage module that are shared resources to the in-house processing unit 20, and may allocate the shared resources 11, except for the network interface module and the storage module, to the external processing unit 30. In this case, the kernel 12 may allocate the shared resources 11 to the in-house processing unit 20 and to the external processing unit 30 using virtualization software, such as VMware software.

The kernel 12 may allocate the in-house resources 21 to the in-house processing unit 20. In this case, the kernel 12 may allocate the in-house resources 21 to the in-house processing unit 20 using a ‘Peripheral Component Interconnect (PCI) pass-through.’ The kernel 12 may allocate the external resources 31 to the external processing unit 30. In this case, the kernel 12 may allocate the external resources 31 to the external processing unit 30 using a ‘PCI pass-through.’

The types of resources allocated by the kernel 12 to the in-house processing unit 20 and the external processing unit 30 will be described in detail. The kernel 12 may allocate a processor, a main memory unit, a storage module, a network interface module, a USB host controller, and a user interface device that are the shared resources 11, and a graphics processing module, an audio processing module, and a USB host controller that are the in-house resources 21 to the in-house processing unit 20. Further, the kernel 12 may allocate a processor, a main memory unit, a USB host controller, and a user interface device that are the shared resources 11, and a graphics processing module, an audio processing module, a USB host controller, a network interface module, and a storage module that are the external resources 31 to the external processing unit 30.

The in-house processing unit 20 includes the in-house resources 21, the in-house OS 22, and the in-house application 23. The in-house processing unit 20 may be allocated the in-house resources 21 by the main processing unit 10. The in-house OS 22 that is an OS for executing the in-house application 23 may be located separately from the kernel 12 and the external OS 32 and may be independently executed.

The in-house application 23 is executed on the in-house OS 22. The in-house processing unit 20 may execute the in-house application 23 based on the processor, the main memory unit, the storage module, the network interface module, the USB host controller, and the user interface device that are the shared resources 11 allocated by the kernel 12, and the graphics processing module, the audio processing module, and the USB host controller that are the in-house resources 21.

That is, the in-house processing unit 20 may access the in-house network using the network interface module belonging to the shared resources 11, provide the data stored in the storage module belonging to the shared resources 11 to other devices over the in-house network, and store data received over the in-house network in the storage module belonging to the shared resources 11.

The external processing unit 30 may include the external resources 31, the external OS 32, and the external application 33. The external processing unit 30 may be allocated the external resources 31 by the main processing unit 10. The external OS 32 that is an OS for executing the external application 33 may be located separately from the kernel 12 and the in-house OS 22 and may be independently executed. The external application 33 is executed on the external OS 32 and the external processing unit 30 may execute the external application 33 based on the processor, the main memory unit, the USB host controller, and the user interface device that are the shared resources 11 allocated by the kernel 12, and the graphics processing module, the audio processing module, the USB host controller, the network interface module, and the storage module that are the external resources 31.

That is, the external processing unit 30 may access the external network using the network interface module belonging to the external resources 31, may provide the data stored in the storage module belonging to the external resources 31 to other devices over the external network and store the data received over the external network in the storage module belonging to the external resources 31.

As described above, the in-house processing unit 20 may access the in-house network using the network interface module physically separated from the network interface module used by the external processing unit 30, and may transmit and receive data using the storage module physically separated from the storage module used by the external processing unit 30. The external processing unit 30 may access the external network using the network interface module physically separated from the network interface module used by the in-house processing unit 20, and may transmit and receive data using the storage module physically separated from the storage module used by the in-house processing unit 20.

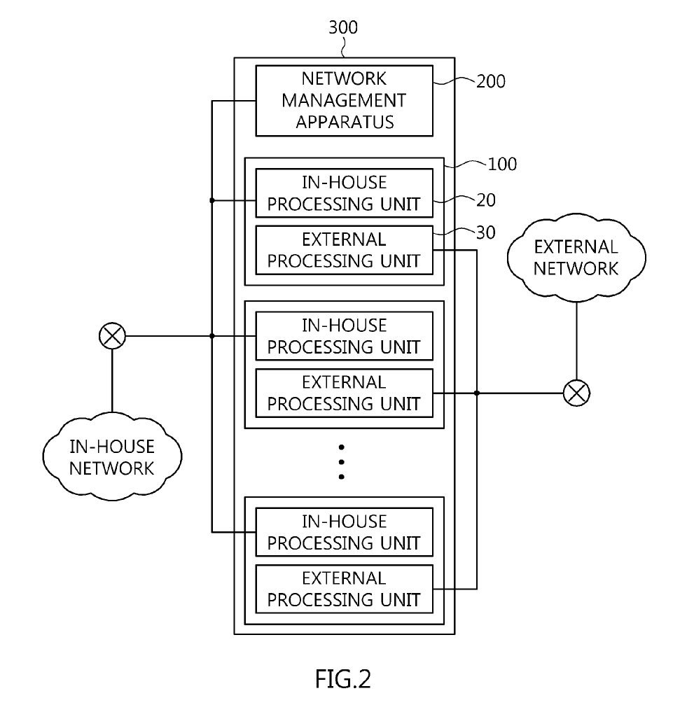

FIG. 2 is a conceptual diagram showing a network separation system according to an embodiment of the present invention.

Referring to FIG. 2, a network separation system 300 according to an embodiment of the present invention may include a network management apparatus 200 and at least one network separation apparatus 100. In this case, the network separation apparatus 100 may include a main processing unit (not shown), an in-house processing unit 20, and an external processing unit 30. The in-house processing unit 20 is connected to an in-house network, and the external processing unit 30 is connected to an external network.

The network management apparatus 200 is connected to the in-house network and may manage the at least one network separation apparatus 100 included in the network separation system 300. That is, the network management apparatus 200 may take charge of the operation, backup, and maintenance of the network separation apparatus 100.

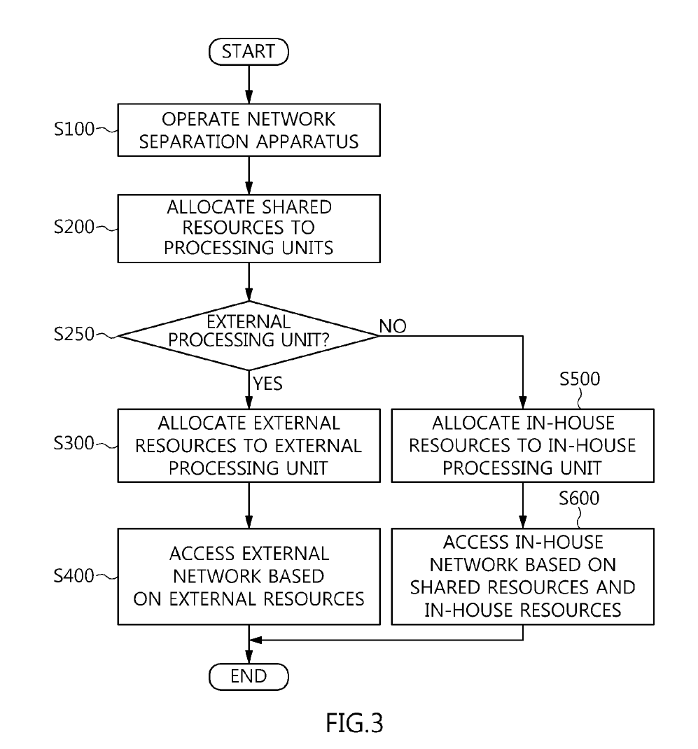

FIG. 3 is a flowchart showing the operation of a network separation method according to an embodiment of the present invention.

Referring to FIG. 3, the network separation method according to an embodiment of the present invention includes the step S100 of operating the network separation apparatus based on shared resources, the step S200 of allocating the shared resources to at least two processing units included in the network separation apparatus, and the steps S300 and S500 of allocating physically separated resources to the at least two processing units according to the network to be accessed. The method may further include the steps S400 and S600 of accessing an external network or an in-house network based on the allocated resources. In this case, the network separation method may be performed by the above-described network separation apparatus. The network separation apparatus may include a main processing unit for allocating resources, an in-house processing unit for accessing the in-house network, and an external processing unit for accessing the external network (see FIG. 1).

Here, the shared resources may include a processor such as a CPU, a main memory unit (for example, RAM or ROM), a storage module such as an auxiliary memory unit (for example, a hard disk), a network interface module such as an MC, a USB host controller, and a user interface device (for example, a display device, a keyboard, a mouse, a touch screen, etc.).

The main processing unit of the network separation apparatus may operate the network separation apparatus based on the shared resources at step S100. That is, the main processing unit may boot the network separation apparatus based on the shared resources, and allocate only shared resources (for example, the processor, the main memory unit, etc.) required for booting to the in-house processing unit and the external processing unit. The in-house processing unit and the external processing unit may be booted based on the allocated shared resources.

After the network separation apparatus has been operated, the main processing unit may allocate shared resources to at least two processing units (that is, the in-house processing unit and the external processing unit) at step S200. The main processing unit may allocate at least one of the network interface module and the storage module that are the shared resources to the in-house processing unit. The main processing unit may allocate the processor, the main memory unit, the USB host controller, and the user interface device that are the shared resources, as well as the network interface module and the storage module, to the in-house processing unit. The main processing unit may allocate the shared resources except for the network interface module and the storage module to the external processing unit. That is, the main processing unit may allocate the processor, the main memory unit, the USB host controller, and the user interface device that are the shared resources to the in-house processing unit. In this case, the main processing unit may virtualize the shared resources based on virtualization software such as VMware software, and allocate the virtualized shared resources to the in-house processing unit and the external processing unit.

The main processing unit may determine whether the network to be accessed is the external processing unit or not at step S250.

After allocating the shared resources to the processing units, the main processing unit may allocate external resources to the external processing unit that accesses the external network at step S300. In this case, the external resources are resources physically separated from the above-described shared resources and in-house resources, which will be described later. The external resources may include a graphics processing module such as a VGA card, an audio processing module such as an audio device, a USB host controller, a network interface module such as an MC, and a storage module such as an auxiliary memory unit (for example, a hard disk). In this case, the external resources are resources required to execute a high-specification external application, and may have better performance than the shared resources. Here, the main processing unit may allocate the external resources to the external processing unit using a PCI pass-through.

The external processing unit that has been allocated the external resources at step S300 can access the external network based on the external resources at step S400. That is, the external processing unit may access the external network using the network interface module belonging to the external resources, provide data stored in the storage module belonging to the external resources to other devices over the external network, and store data received over the external network in the storage module belonging to the external resources. In this case, the network interface module and the storage module that are external resources are physically separated from the shared resources. Accordingly, the external processing unit may access the external network using the network interface module physically separated from the network interface module used by the in-house processing unit, and may transmit and receive data using the storage module physically separated from the storage module used by the in-house processing unit.

Further, the external processing unit may execute an external application based on the processor, the main memory unit, the USB host controller, and the user interface device that are the allocated shared resources and based on the graphics processing module, the audio processing module, the USB host controller, the network interface module, and the storage module that are the allocated external resources.

After allocating the shared resources to the processing units, the main processing unit may allocate in-house resources to the in-house processing unit that accesses the in-house network at step S500. In this case, the in-house resources are physically separated from the above-described shared resources and external resources. The in-house resources may include a graphics processing module such as a VGA card, an audio processing module such as an audio device, a USB host controller, etc. The in-house resources are resources required to execute a high-specification external application and may have better performance than the shared resources. In this regard, the main processing unit may allocate the in-house resources to the in-house processing unit using a PCI pass-through.

The in-house processing unit that has been allocated the in-house resources at step S500 can access the in-house network based on the shared resources at step S600. That is, the in-house processing unit may access the in-house network using the network interface module belonging to the shared resources, provide data stored in the storage module belonging to the shared resources to other devices over the in-house network, and store data received over the in-house network in the storage module belonging to the shared resources. In this case, the network interface module and the storage module that are the shared resources are physically separated from the external resources. Accordingly, the in-house processing unit may access the in-house network using the network interface module physically separated from the network interface module used by the external processing unit, and may transmit and receive data using the storage module physically separated from the storage module used by the external processing unit.

Further, the in-house processing unit can execute an in-house application based on the processor, the main memory unit, the storage module, the network interface module, the USB host controller, and the user interface device that are the allocated shared resources and based on the graphics processing module, the audio processing module, and the USB host controller that are the allocated in-house resources.

In accordance with the present invention, since an in-house network and an external network can be physically separated within a single device, internal important information can be effectively protected. That is, the security of the entire network can be improved.

Further, the present invention can prevent processing capability from being deteriorated even when traffic explosively increases.

Furthermore, the present invention can efficiently utilize a workspace and construct a network at low cost.

As described above, in the network separation apparatus and method according to the present invention, the configurations and schemes in the above-described embodiments are not limitedly applied, and some or all of the above embodiments can be selectively combined and configured so that various modifications are possible.

What is claimed is:

1. A network separation apparatus comprising:
a main processing unit for allocating resources according to a network to be accessed;
an in-house processing unit for accessing an in-house network using the resources allocated by the main processing unit; and
an external processing unit for accessing an external network using resources, physically separated from resources used by the in-house processing unit, among the resources by the main processing unit.

2. The network separation apparatus of claim 1, wherein the main processing unit allocates a network interface module belonging to shared resources to the in-house processing unit, and allocates a network interface module physically separated from the shared resources to the external processing unit.

3. The network separation apparatus of claim 1, wherein the main processing unit allocates a storage module belonging to shared resources to the in-house processing unit, and allocates a storage module physically separated from the shared resources to the external processing unit.

4. The network separation apparatus of claim 1, wherein the main processing unit allocates in-house resources used to execute an in-house application to the in-house processing unit, and allocates external resources, physically separated from the in-house resources and used to execute an external application, to the external processing unit.

5. The network separation apparatus of claim 1, wherein the in-house processing unit provides data, stored in a storage module belonging to shared resources among the resources allocated by the main processing unit, over an in-house network, and stores data received over the in-house network in the storage module belonging to the shared resources.

6. The network separation apparatus of claim 1, wherein the external processing unit provides data, stored in a storage module physically separated from a storage module used by the in-house processing unit among the resources allocated by the main processing unit, over an external network, and stores data received over the external network in the storage module physically separated from the storage module used by the in-house processing unit.

7. A network separation method, the method being performed by a network separation apparatus for physically separating an in-house network and an external network, comprising:
allocating shared resources to at least two processing units included in the network separation apparatus; and
allocating physically separated resources to the at least two processing units according to a network to be accessed.

8. The network separation method of claim 7, wherein the allocating the shared resources to the at least two processing units included in the network separation apparatus is configured to allocate at least one of a network interface module and a storage module that are the shared resources to a processing unit, which accesses the in-house network, among the at least two processing units.

9. The network separation method of claim 7, wherein the allocating the physically separated resources to the at least two processing units according to the network to be accessed is configured to allocate in-house resources used to execute an in-house application to a processing unit, which accesses the in-house network, among the at least two processing units.

10. The network separation method of claim 7, wherein the allocating the physically separated resources to the at least two processing units according to the network to be accessed is configured to allocate external resources used to execute an external application to a processing unit, which accesses the external network, among the at least two processing units.

11. The network separation method of claim 7, wherein the allocating the physically separated resources to the at least two processing units according to the network to be accessed is configured to allocate at least one of a network interface module and a storage module that are physically separated from the shared resources to a processing unit, which accesses the external network, among the at least two processing units.

12. The network separation method of claim 7, wherein after the resources have been allocated according to the network to be accessed, the in-house network is accessed based on a network interface module belonging to the shared resources among the allocated resources.

13. The network separation method of claim 7, wherein after the resources have been allocated according to the network to be accessed, the external network is accessed based on a network interface module physically separated from a network interface module belonging to the shared resources among the allocated resources.
